(19) United States
(12) Patent Application Publication
(10) Pub. No.: US 2003/0001904 A1
(43) Pub. Date: Jan. 2, 2003

(54) Multidimensional multimedia player and authoring tool

(76) Inventors: Jon C. Rosen, Woodland Hills, CA (US); Robert E. Rosen, Agoura Hills, CA (US)

Correspondence Address: Oppenheimer Wolff & Donnelly LLP, Suite 3300, 45 South Seventh Street, Minneapolis, MN, 55402-1609, US

(21) Appl. No.: 09/866,235

(22) Filed: May 25, 2001

(51) Int. Cl. G09G 5/00

(52) U.S. Cl. 345/848

(57) ABSTRACT

A tool for generating a standardized multimedia presentation is disclosed as well as a viewer for presenting such a presentation. The tool assists a developer in setting up a number of categories for the presentation, each of which has a number of subcategories. For each subcategory, content files are associated. If the content file is a video, then a module can assist the developer in associating tangential content which will be displayed to the end user at pre-set points during the playing of the video. After the presentation is built, the end user can view the presentation. It is presented to the user through a graphical user interface in the form of a three-dimensional geometric object, such as a 3-by-3 cube. The end user can choose any topic from the cubes and then choose any subtopic. The associated content (and perhaps tangential content) is then presented to the end user. The user can freely browse from among the categories and subcategories. The presentation player itself is quite flexible and extensible as it is based on a series of scripts which describe the various components of the user interface and the content files to be played for the end user. This allows a single presentation engine to be distributed at one time and then presentations can be distributed which contain their content and any new or modified functionality from the original presentation system.

### BACKGROUND OF THE INVENTION

This invention relates generally to multimedia presentations. Particularly, this invention relates to a method of generating a multimedia content presentation based upon pre-existing multimedia content and a set of standardized designs and allowing a person to access the presentation with a specialized graphical user interface.

In the prior art, multimedia presentations have developed to combine audio, video, computer graphics, and other content forms for improved presentation to the viewer as a multimedia experience. Such multimedia technologies have taken content from many different areas and have developed high quality, interactive, presentations. For example, using the “Orientation Cube,” a prior art product sold by L3i Interface Technology Ltd. (which is incorporated by reference into this application). The prior art Orientation Cube system offers one particular way of presenting the multimedia content for presentation. The approach uses a geometric representation of a cube, which is sub-divided into component cubes, much like the famous Rubik's Cube puzzle of the early 1980's. Each component cube represents a particular portion of a multimedia presentation. The viewer picks and chooses from the various component cubes to display the various pieces of multimedia content for the presentation.

In other types of multimedia presentations in the prior art, the pieces of content are joined together using HTTP hyperlinks. Such presentations can be viewed using a web browser and allow the viewer to see a page of content and then use links to move either to the next page of content or to the previous page of content. Hyperlinks can also be used to provide additional information about highlighted terms, such as definitions.

In yet other types of multimedia presentations, the content is pieced together into a “movie” which is presented to the viewer sequentially from start to finish. FLASH and other commercially available software products can be used to design and create such types of presentations. While FLASH and similar products can create presentations of high quality and polish, they lack the ability to allow the viewer to meander through the presentation in a personalized and standardized manner.

The prior art of multimedia presentations lacks any underlying consistency between different presentations for different subjects. In the prior art, even though the final output may be similar, the structure of each presentation may have substantial differences. There is no uniform and consistent way of taking content from any topic and methodically and efficiently developing consistent, similarly-structured, multimedia presentations.

The prior art also lacks a method of developing interactive multimedia presentations wherein a user can experience a consistent type of structure with predetermined standards in each presentation. In the prior art, substantial differences in the structure in each multimedia presentation may result in a program that is difficult to follow from presentation to presentation. Some of the available methods in the prior art require the user to proceed through the presentation sequentially, much like reading a book. Other methods present the viewer with a choreographed sequence which prevents the user from access the information as he or she desires.

### SUMMARY OF THE INVENTION

One object of the present invention is to provide a method for standardizing the transformation of pieces of content into a multimedia presentation, thus allowing for greater efficiency in creating different presentations. The method should assist the author in creating a presentation which is assembled in a hierarchical manner, allowing the user to browse the various categories and subcategories of the content. Another object of the invention is to provide a method allowing the author to easily connect various pieces of content so that supportive content is automatically presented to the viewer when the viewer chooses certain primary content. Yet another object of the invention is to provide a method that creates a presentation which is displayed to the viewer via a graphical user interface that is easy to navigate and which displays the subject matter of the presentation as a series of categories and subcategories. Such a common graphical user interface and common method of assembling a presentation for a viewer should provide greater consistency between different presentations.

These and other objects are achieved by the present invention that includes a tool for generating a standardized multimedia presentation for a topic based upon predetermined content as well as a multimedia player for such presentations which is readily extensible and maintained. Preferably, these items are implemented as computer applications running on a computer system, and/or made available over the Internet or other network.

The authoring tool of the present invention provides a systematic method of organizing disparate content into a hierarchical collection of categories and subcategories. The differing types of content are associated to content formats which determine how the content will be presented on a display to the user. The computer system allows for the determination of how many categories to provide in the finished presentation as well as how many subcategories per category. These categories can be associated with a graphical user interface wherein the graphical representation is comprised of a series of category-identifying components and a series of subcategory-identifying components. In one preferred embodiment, the graphical user interface is in the form of a three-dimensional cube made up of a series of smaller cubes. In other embodiments, the graphical user interface is displayed to the user as another object.

The authoring tool loops through each of the categories for the presentation and assists the computer user in associating titles to the category. For each of the subcategories within each of the categories, the system and user may associate a title and/or content files to the subcategory.

Once the presentation has been created, the present invention also provides a multimedia player that operates from a script. The main ‘engine’ of the player is an executable program which then parses the script to dynamically load new components needed to support the specific graphical user interface and presentation. Then a script is parsed to set up the presentation, including the naming of the category elements and subcategory elements as well as determining what content should be displayed to the user upon certain events within the user interface. Then customized graphical representation of the graphical user interface is displayed to the user on a display device and the user can freely browse from among the category and subcategory elements. Once a subcategory is selected, the associated content file is displayed or played for the viewer.

Other objects and advantages of the present invention will become more apparent to those persons having ordinary skill in the art to which the present invention pertains from the foregoing description taken in conjunction with the accompanying drawings.

### BRIEF DESCRIPTION OF THE DRAWINGS

FIG. 1 is a diagram of one embodiment of the present invention describing the components of a software system for generating a standardized multimedia presentation.

FIG. 2 is a flow chart of one embodiment of the present invention, which describes the process of developing a multimedia presentation.

FIG. 3 is a diagram of one embodiment of the present invention showing the components of a content template.

FIGS. 4 and 5 are flow charts of one embodiment of a video authoring tool which can be a used to prepare content for the present invention, which describes the process of authoring multimedia content.

FIG. 6 is a diagram of one embodiment of the present invention, showing the components of a content template.

FIGS. 7 and 8 are diagrams of the present invention showing the components of a graphical interface for navigating content.

FIG. 9 is a diagram of an embodiment of the present invention, showing the components of a graphical interface for navigating a presentation created by the present invention.

FIG. 10 is a block diagram illustrating how the presentation engine relies on script data files to provide the graphical user interface to the end user.

### DETAILED DESCRIPTION OF THE PREFERRED EMBODIMENTS

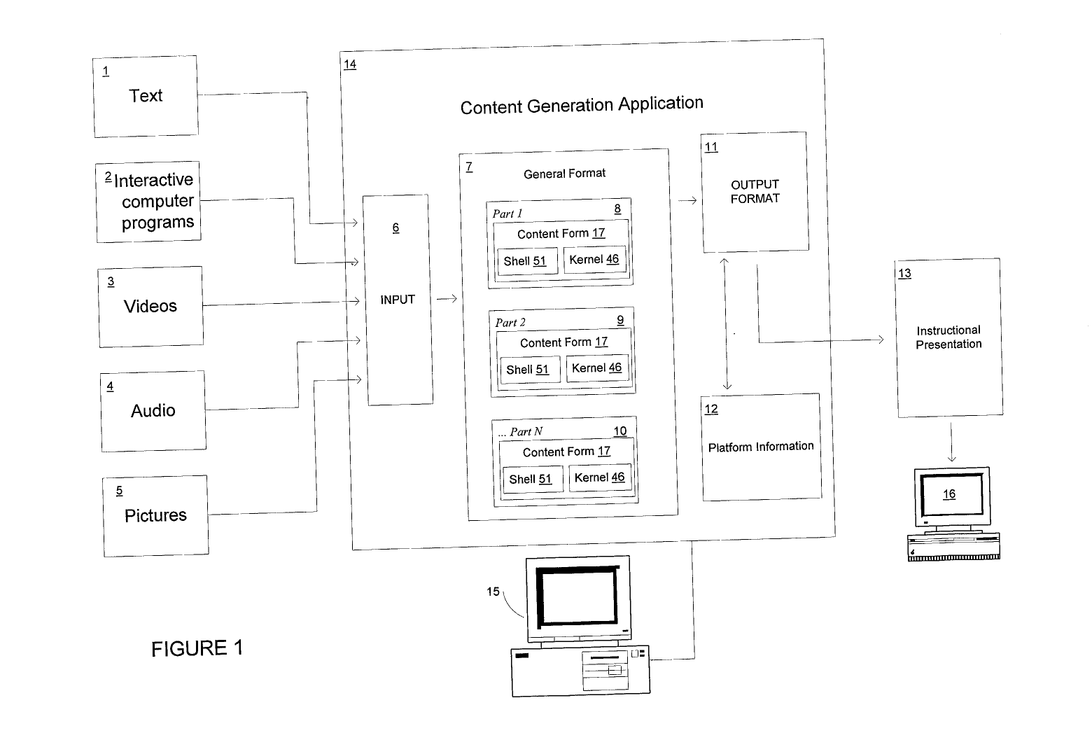

In one embodiment of the invention, the system shown in FIG. 1 can be used by a user to develop a multimedia presentation 13 on a given subject. For discussion purposes, suppose the subject for the presentation is “Martial Arts.” The method of the present invention uses the computer system to collect pre-existing content, such as audio content 4, video content 3, graphics/pictures 5, text 1, interactive computer programs (such as applets) 2, and other types of multimedia content (such as HTML content).

Once the various pieces of content 1-5 are collected for input 6 into the content generation application 14, the content pieces are standardized to meet a general format 7 which defines the requirements, boundaries, and the like, of the content. The general format 7 may include a single format specification part 8, or general format 7 may include a number of format specifications parts 8-10 which can be used in assembling the presentation 13. Each format specification part 8-10 has its own content requirements, known as the part's content form 17. The content form 17 includes a shell 51, and a kernel 46 (described below).

For standardization, certain content pieces may need to be translated or transformed by the content generation application 14 into new formats acceptable to the general format 7. Once all content is formatted, an output module 11 develops the instructional presentation 13 based on platform information 12. The resulting instructional presentation 13 may be a stand-alone computer program developed for a variety of hardware and software platforms 16. In the alternative, the resulting instructional presentation 13 may be a set of HTML code which can be downloaded to the viewers over a computer network and viewed on a browser. Of course, there are other forms which the instructional presentation 13 can take, all within the scope of this invention.

A. The Use of Categories and Sub-Categories

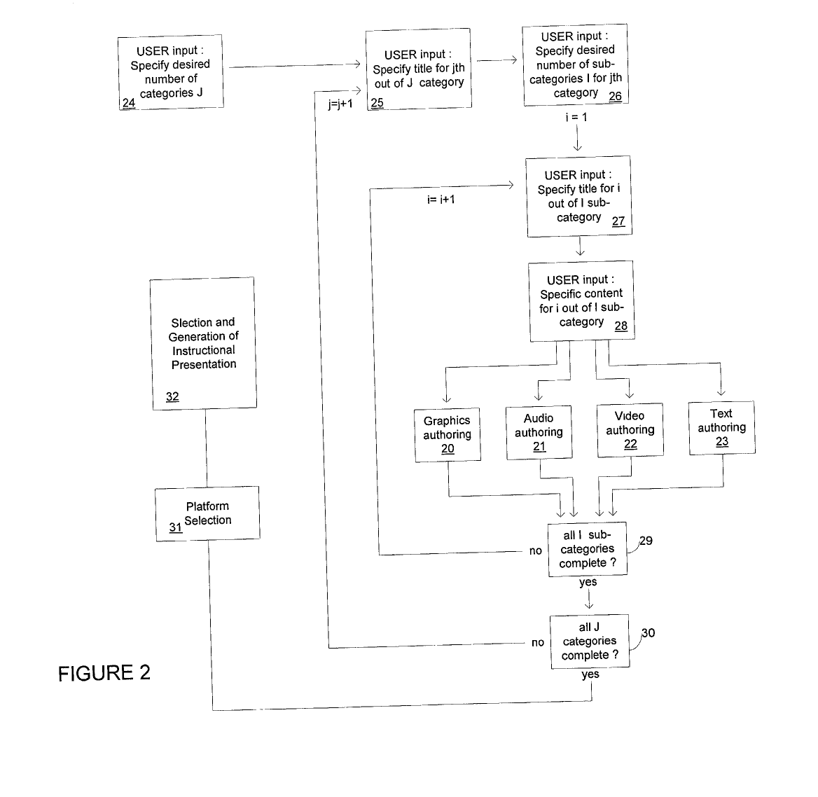

FIG. 2 illustrates a flowchart representing one embodiment of the present invention's method, which describes the process of assisting an author to generate an instructional presentation through a content generation application 14. In the embodiment, the author may define a portion of the general format 7 (FIG. 1) by specifying the number of topics and sub-topics. The author also makes design choices regarding the content forms.

The process in FIG. 2 may be implemented as a software program running on a variety of computer hardware and operating system platforms. For example, the hardware platform may be based upon architectures by Intel, AMD, Sun Microsystems, SGI, IBM, HP, Apple, Motorola and others. The process described in FIG. 2 may be programmed in a variety of languages including C, C++, Java, MSVC++, Pascal, Smalltalk, Visual Basic, JavaScript, HTML and others. The process described in FIG. 2 may be programmed for a variety of different operating systems such as Windows, Unix, posix compliant operating systems or MAC OS.

Generally, the software tool diagrammed in FIG. 2 allows an author to create a multi-dimensional multimedia presentation which consists of a series of categories and a series of subcategories for each of those categories. Later, when the end user views the presentation, the end user can choose any subcategory. By doing so, the content associated to that subcategory will be displayed. Sometimes, additional, tangential content will also be displayed to the end user. For example, in some cases, the content for a subcategory may be a video. The video may address several points or topics. As the video plays for the end user, tangential content—perhaps audio, text, or even another video—can also be accessed by the end user to explain in further detail the various points or topics. The end user can view and browse through the tangential content and then return to the primary content (such as the video) at any time. Both forms of content (the primary as well as the tangential) are controlled by the end user through control panels. Thus, there may be a primary control panel as well as a tangential control panel.

FIG. 2 shows a flowchart of the present invention's authorship tool, which assists a developer in creating the organized multimedia presentation. In the embodiment in FIG. 2, the author inputs number of desired categories J 24. Alternatively, the number of desired categories J may be predetermined and thus not explicitly input by the author. Once the content generation application 14 is configured with the number of categories J within the presentation, an iterative process then begins at 25 where the title (or other descriptive information) for the first category (j=1, where j is the current category of all categories J) is defined. In the exemplary presentation of “Martial Arts,” the first category may be a “Background” on Martial Arts. The number of desired sub-categories I for the current “Background” category is then specified 26 either by the user or by a predetermined number stored in the general format 7.

Another iterative process then begins at 27 where the title (or other descriptive information) for the first sub-category (i=1, where i is the current sub-category of all sub-categories I) of the main category “Background” is defined. For example, for the first (j=1) category of “Background,” the first (i=1) desired subcategory might be “History.”

In step 28, predetermined multimedia content is then input according to the current category and sub-category. In this exemplary embodiment, the author user defines the type of multimedia content to be associated with the current sub-category. In an alternative embodiment, the type of multimedia content to be input may be pre-specified. The content may be video 3, text 1, audio 4, graphics 5, interactive programs 2, or any other type of multimedia content, or combination thereof. For example, for the subcategory “History” of the category “Background” of the presentation on “Martial Arts,” it may be desired to input a video of the history of martial arts with accompanying text and audio. Alternatively, the multimedia content may be in a standardized file format.

The iterative processes for all J categories and all I subcategories for each J category repeats until all multimedia content is associated with each subcategory of each category (see steps 29 and 30). The method for inputting content and generating an output file, which structures the content to a presentation format, is described below.

B. Content Forms

The content form(s) 17 of the present invention define the format of how the multimedia content will be presented to the user. In a given presentation, which may contain videos, text, audio clips, etc., there may be the need for several content forms—one for each type of content to be presented. The content generation application 14 creates a presentation interface integrating the multimedia content by using as input both the content forms 17 and the multimedia content 1-5.

Steps 20-23 of FIG. 2 represent the authoring phase in the content generation application 14 that transforms preexisting multimedia content 1-5 into a format compatible with the content form(s) 17 for each sub-category. For example, if the content to be added to the presentation is a video, then the video authoring unit 22 may assist the developer in associating tangential content to the video at specified times, as discussed above and below. The editing phase 20-23 may also allow an author to develop a customized content form. Alternatively, the content form may be predetermined. An author may also choose from among a variety of content forms.

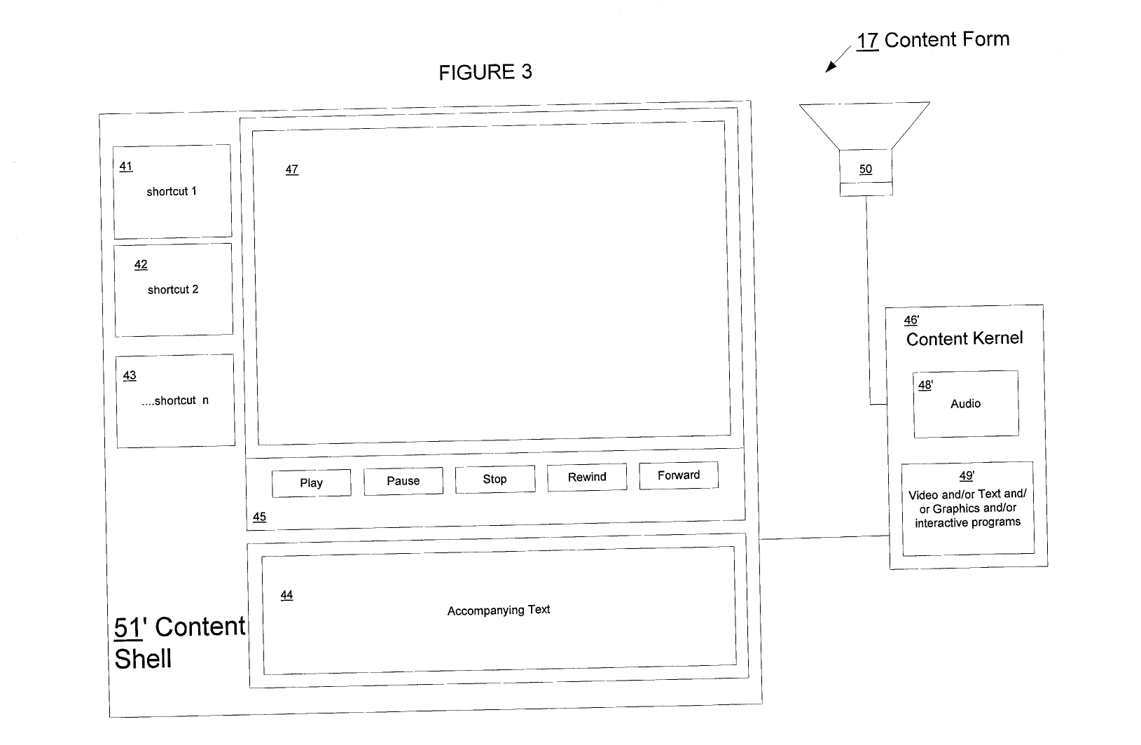

FIG. 3 shows the content form 17 from the content generation application 14 in more detail. As shown in FIG. 3, the content form 17 contains a content shell 51 and a content kernel 46. The content shell 51 is a user interface template for structuring various multimedia content. The content kernel 46 is one or more data files that contains all the necessary multimedia content, in the appropriate formats, for the content shell 51 to use.

FIG. 3 illustrates a one example of a content form 17. Many different content forms may be used to organize multimedia content in a variety of topological structures in the content shell 51 and with differing file formats for the various content types in the content kernel 46. For example, the content shell 51′, of the content form 17 in FIG. 3 defines a video playing in a main window 47. Commands 45 control the video, accompanying text 44 or other multimedia content and predetermined images in shortcut boxes 41-43. The accompanying text 44 may be information related to information in the main window 47. As the video is playing, a user may read or scroll through associated text 44 or other multimedia content. The predetermined images in the shortcut boxes 41-43 are selectable by a user and may initiate an event. For example, selecting an image may cause a “jump” to a particular scene in the video playing in the main window 47 or may activate other multimedia content in the main window 47. The content shell 51 also includes an audio source 50. The audio source is an interface to a sound source, such as a speaker.

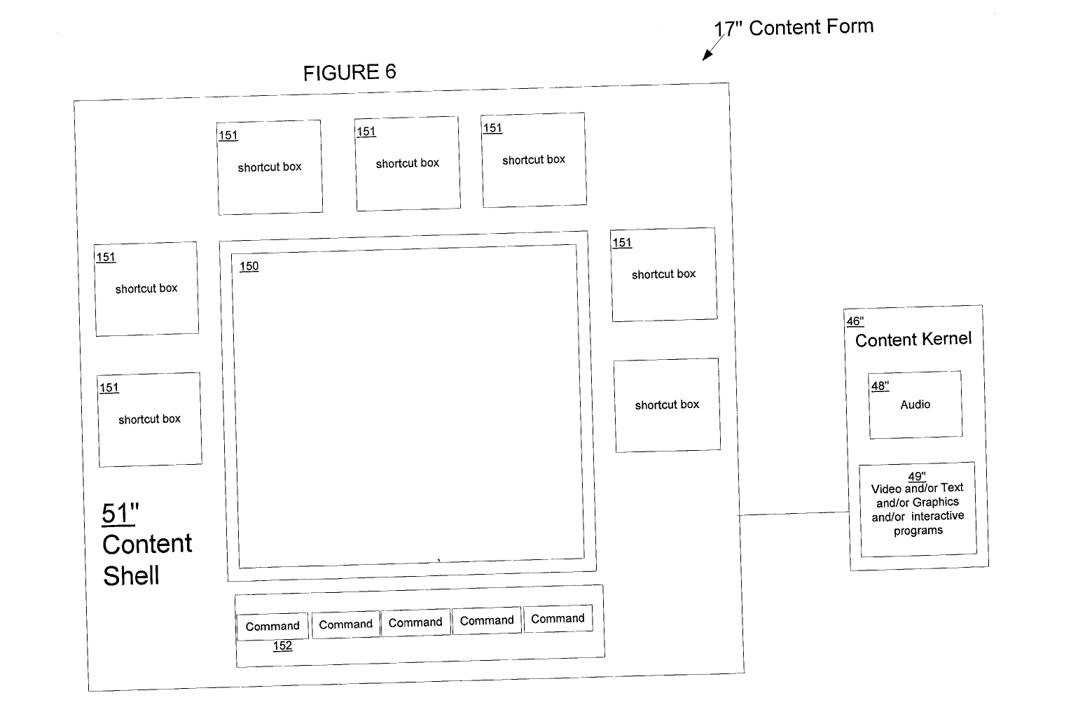

FIG. 6 is an another example content form 17″ having a content shell 51″ and content kernel 46″. This content form 17″ defines an instructional video playing in a main window 150 including video control commands 152. As a video plays in the main window 150, predetermined events start occurring in shortcut boxes 151 at predetermined times. As an example, the predetermined event may be the appearance of a predetermined image. Once an image appears in a shortcut box 151, the image is selectable by a mouse click or other input method. When a shortcut box 151 is selected, the video or other multimedia content executing in the main window 150 pauses and a second, tangential presentation begins. The second presentation can begin in the main window 150 or anywhere else in the content shell 51″. The second presentation relates to the concept depicted by the selected event in the shortcut box 151. The second presentation can be of variable format, such as text, video, graphic image, interactive program, web browser, etc. In one exemplary embodiment, the second presentation becomes visible in the main window 150 and another control panel appears in the control command area 152 giving the user navigational control over the second presentation. If the second presentation is text, the user may be able to use scrolling, paging and other text control buttons. If the second presentation is a video the user may be given another set of video control buttons.

In other embodiments, the content form 17 may also specify interactive programs, such as games, floating step instructions, puzzles or electronic quizzes that are run in the main window 47/150. The interactive programs may be written in a variety of languages, such as, but not limited to, C, C++, Java, MSVC++, Pascal, Smalltalk, Visual Basic, JavaScript, HTML, etc. As an example, for the “Martial Arts” presentation's sub-category of “History” (within the category of “Background”), the content form 17 may specify an interactive quiz that tests a user on the material presented. The content form 17 may also specify interactive text 44 accompanying the presentation in the main window 47/150. The content form 17 may also specify an Internet web browser, which may contain content, related to the specific sub-category. The web browser may contain interactive text, graphics, videos, sounds, or other multimedia content suited for display in a web browser.

One skilled in the art will recognize that the content generation application 14 can readily support many differing parts 8, 9, 10 which each include differing content forms 17. The different parts 8, 9, 10 allow the author of a presentation 13 to merge many types of content into a presentation 13. As new multimedia capabilities develop in the industry, new parts and content forms 17 can be configured to handle them. For example, there are currently companies, such as DigiScents, Inc. that are developing a new computer peripheral which will allow computer developers to transmit scents to the computer user. It is within the scope of the present invention that should such scent technology be marketed, a content form 17 could handle the integration of various scents into a presentation 13. For example, a presentation 13 on American Flora could include the ability to have the user experience the aroma emitted by each flower.

C. File Formats

During multimedia authoring 20-23, the components of the content shell 51 are defined and saved in one or more data files by the content kernel 46. These data files may include video or text or graphics data file(s), or interactive programs or web content 49 or audio data file(s) 48, for example. The multimedia content 1-5 integrated with the content form 17 in the present invention must be in a compatible format with the content form 17. For example, a video file 49 in the content kernel 46, which is to be displayed in the main window 47/150 of the content shell, may have a certain format requirement, such as AVI, MPEG or QuickTime or Windows Media or any other video playback technology known to one ordinarily skilled in the art. Typically, an individual MPEG or AVI or QuickTime or Windows Media file contains a file header and control information containing video or audio data to define the contents of the video file. The content form 17 may also specify the various attributes of a given file, such as video resolutions or compression formats or audio formats or quality.

Format requirements and file attributes may also apply to text files, graphics files, audio files, and other multimedia files, to be used with the content shell 51, such as, but not limited to, HTML document files, TXT document files, DOC document files, PDF document files, WPD document files, JPEG/JPG image files, TIFF image files, GIF image files, BMP image files, WAV audio files, MP3 audio files, REAL audio files, or any other document, image, or audio format known to one skilled in the art. It is to be understood that the video, audio, text, and graphics formats employed may be customized formats utilizing well-appreciated formatting algorithms or encoding and decoding techniques. The content form 17 may also specify the various attributes of a given file, such as size or resolution or compression, or quality or any attribute that applies to video, audio, and graphics files.

D. Format Conversion

If the pre-existing multimedia content 1-5 is not already in the format specified by the content form 17, the content generation application 14 of the present invention transforms the content into the appropriate format or into a file with the appropriate file attributes. Format conversion may involve converting one file format into a different file format or changing file attributes such as size, resolution, quality, or compression. Format conversion may involve video format files, audio format files, image format files, or document format files. Pre-existing software for file format conversions, well known to one skilled in the art, may be utilized by the content generation application 14 for the format conversion process.

As a specific example, it may be desired to use a video presentation of the history of martial arts which is stored in a file format different from the one used by the content form 17, and with a different resolution specified by the content form 17. For proper integration with the content form 17, the video presentation is converted to the appropriate format. File formats such as MPEG, AVI, and QuickTime may include control information wrapped around video and audio data. Thus file conversion would involve, at a rudimentary level, stripping one kind of format header, and then pasting back the same information with a different format header. Intel has released a free utility called “SmartVid” for Windows to convert between AVI and QuickTime format by changing the file header information. SmartVid converts video files regardless of the codes used to compress them. Another video conversion program, “TRMOOV,” has been made available by the San Francisco Canyon Company and can be downloaded from various sites on the World Wide Web. There are many well-appreciated ways to convert file formats and file attributes from video files, image files, document files, and or audio files, either by using pre-existing programs, or algorithms well known to one ordinarily skilled in the art. In an alternative embodiment, a propriety file format conversion program may be used, utilizing various conversion algorithms.

E. Filling in the Content Shell: Video and Image Editing

The content form 17 represented by FIG. 3 is just one exemplary way of structuring the multimedia content for presentation to a viewer. The content shell 51″ defines a main window 47, and n-number of shortcut boxes 41, 42, 43, which “jump” to particular playback points in the video 49′ stored in the content kernel 46′. FIG. 3 shows, by way of example, three shortcut boxes 41-43. It is important to note that the video playback during content editing is different from that of the video playback in the content shell as seen by a viewer during the presentation. It is to be understood that there may be any number of shortcut boxes, and they may be structured in various graphical ways in the content shell 51′.

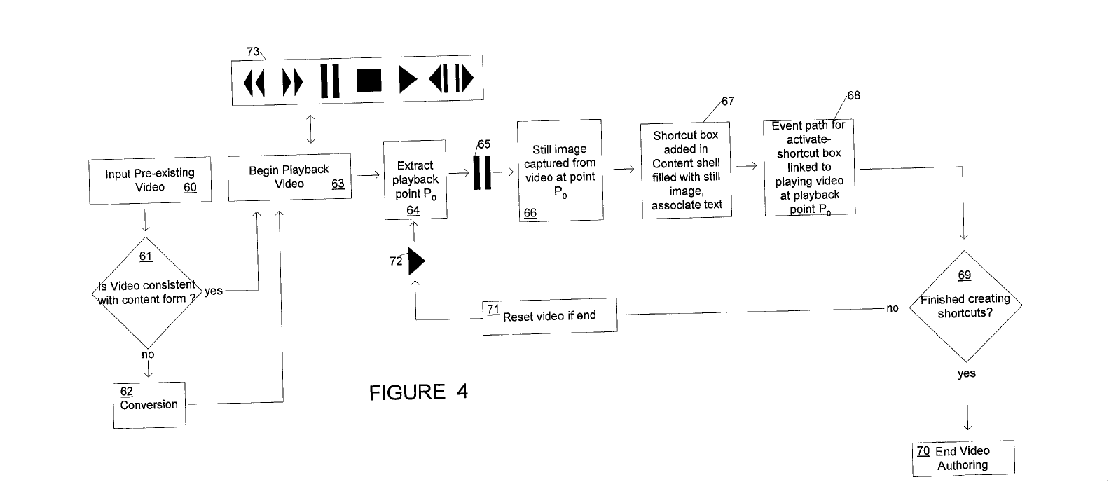

FIG. 4 illustrates an exemplary method for multimedia content editing 20-23 of the content shell in FIG. 3 where the shortcut boxes in the content shell 51 link predetermined multimedia images or text to playback points of the video. In the present embodiment, the author of a new presentation first inputs a pre-existing video 60 into the content generation application 14 during content editing 20-23. If the video is consistent with the content form 17, the video begins to play (61 and 63). If however, the video is inconsistent with the content form 17, a conversion of formats 62 precedes the video playback 63. The author may, at any time, use video controls 73 to control the video, such as with controls to fast forward, reverse, pause, stop, play, or play in slow motion. In FIG. 4, the controls are graphically shown with their common symbols.

At any desired point in the video, the author may choose and extract a playback point P0 from the video 64. The playback of the video during content authoring is then paused 65 and a shortcut box in the content shell 51′ is associated with the playback point P0. A still image of the video at the playback point is captured 66 and the shortcut box in the content shell 51′ is filled with the captured image 67. The author may also associate text or a clipped video segment with the added shortcut box. A specific event is then chosen 68 for activation of the shortcut box. For example, a shortcut box may be activated during execution if a user clicks on it with a mouse or uses some other input method. In the exemplary embodiment illustrated in FIG. 4, the event path for activation of the shortcut box is linked to playing the video in the main window at the playback point P0. If the author is finished with adding shortcut boxes, the video editing ends 70. Otherwise, the playback resumes 71 and 72.

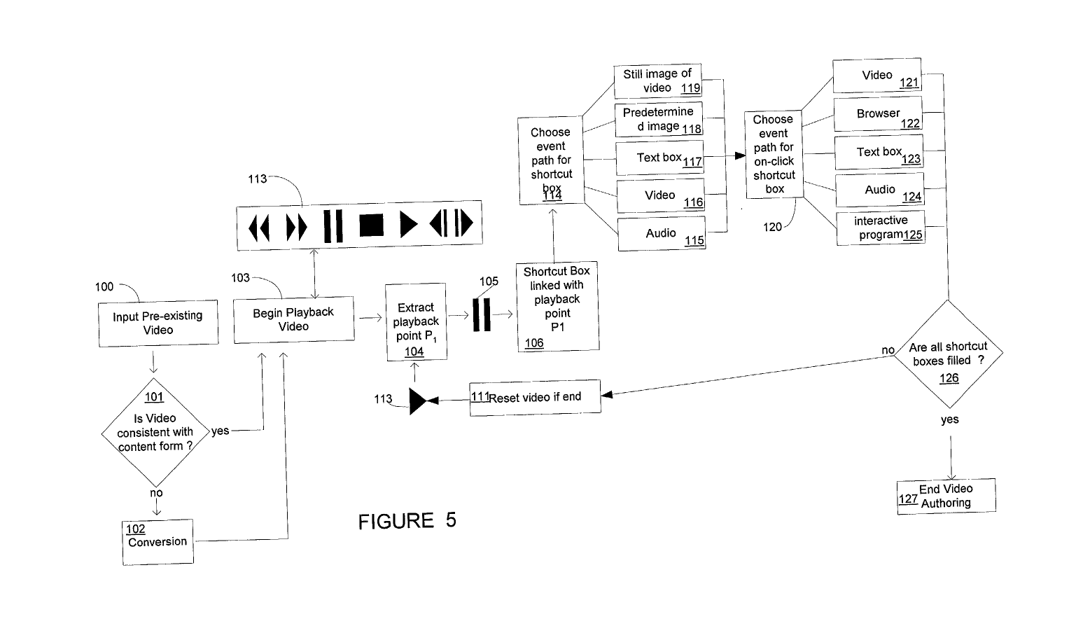

FIG. 5 illustrates another version of multimedia content editing. In FIG. 5, the flowchart represents multimedia content editing 20-23 of a content shell where the shortcut boxes in the content shell link predetermined multimedia images or text to predetermined multimedia content. In the present embodiment, a pre-existing video is first input 100 into the content generation application 14 during content editing 20-23. If the video is consistent 101 with the content form 17, the video begins to play 103. If however, the video is inconsistent with the content form, a conversion of formats 102 precedes the video playback 103. As previously explained, the author may, at any time, use video controls 113 to fast forward, reverse, pause, stop, play, or play in slow motion the video.

At any desired point in the video, the author may extract a playback point P1 from the video 104. The playback of the video during content authoring is then paused 105 and a shortcut box in the content shell is linked 106 to the playback point P1. In other words, linking a shortcut box to the playback point P1 in the this embodiment means that during video playback in the content shell, an event will occur in the shortcut box whenever the video reaches the playback point P1. A specific event is then chosen 114 for the shortcut box. The author may choose from a variety of event paths that will execute at the point P1 during video playback in the content shell. Exemplary event paths may include, but are not limited to, the appearance of the still image of the video 119 taken at P1, the appearance of a predetermined image 118, an interactive text box 117, another video 116, or an audio program 115 standing alone or in combination with any other event path or a web browser. For example, as illustrated in FIG. 6, if the event path chosen is the still image of the video 119, then during playback of the video, the still shot of the video taken at playback point P1 during content authoring will appear in the shortcut box at point P1 during playback in the content shell.

The activation of the shortcut box may then be linked with another event 120, such as a predetermined video 121. In such a situation, while viewing the presentation, if the viewer activates the shortcut box 151 by clicking on it, or by some other input method, the predetermined video 121 begins to play in the content shell. The predetermined video 121 may play in the shortcut box 151, or in the main window portion of the content shell 150, or anywhere else in the content shell 51″. A user may link the activation of the shortcut box 120 with a variety of events, such as, but not limited to, activating an interactive program 125, a web browser 122 which may be embedded in the content shell, an interactive text box 123, or an audio program 124 alone or in conjunction with one of the other event paths. Once the author is finished creating shortcuts 126, the video editing ends 127. Otherwise, the playback resumes 111, 113.

F. Output Form and the Finished Presentation

Returning attention to FIG. 2, once all of the content editing 20-23 is complete 30 for every subcategory i of each category j, each subcategory of each category will have a content form 17 filled. At this point (31 and 32), an output form is generated 11 which takes all of the collective content information in the general format 7 and generates a user interface to navigate the content for the appropriate platform. When executed, the output form 11 is a graphical and/or audio user interface for depicting all of the information in the general format 7.

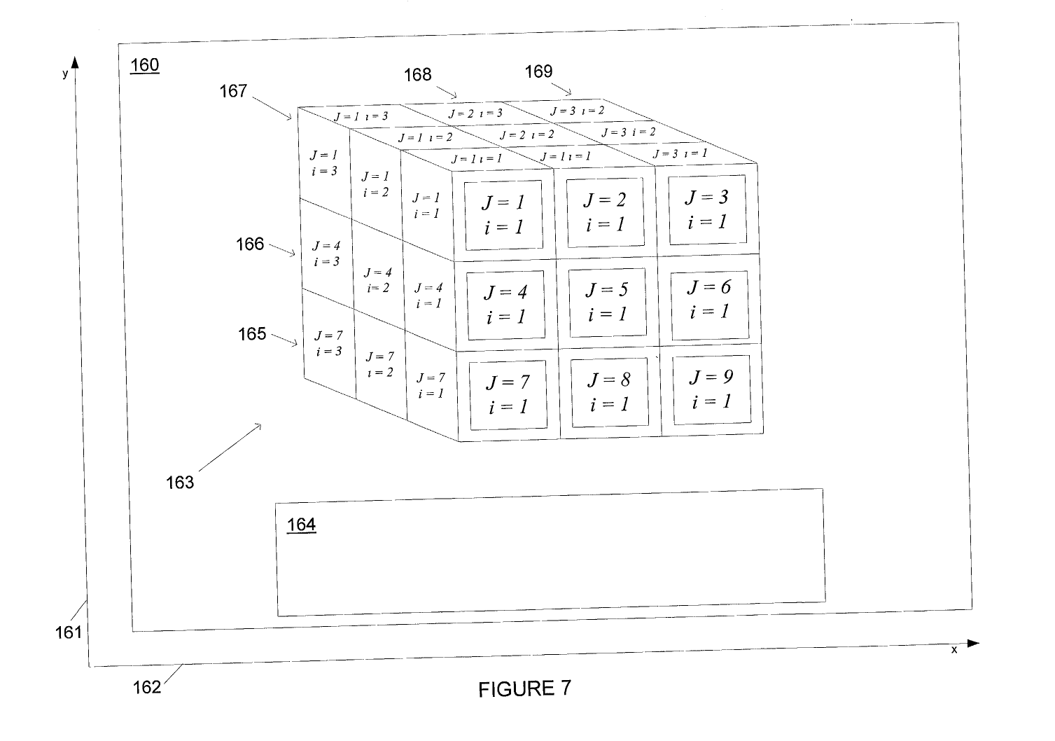

The user interface for the resulting presentation 13 can take any desired form. One such form is shown in FIGS. 7 through 9. FIG. 7 represents an exemplary output form that graphically depicts, in the form of a 3-by-3 cube 163 comprised of 27 component cubes. The cube 163 shows to the viewer all of the presentation's categories (J=1 through 9) on its face. In this exemplary embodiment, the cube 163 is a two dimensional projection of a three dimensional cube. Of course, in other embodiments, the cube could be more realistically rendered as a three-dimensional object having the proper shading, etc.

The cube 163 is a modular geometric object which has J*I components. For example, if the general format 7 specifies nine categories (J=9) and three subcategories for each category (I=3), the content generation application will generate an output form with a geometrical entity 163 shown in FIG. 7, having a face for 9 categories and comprised of J*I (i.e., 27) component cubes for the 27 total subcategories. Using the example of a presentation for Martial Arts, the viewer of the presentation is presented with the cube of FIG. 7. The component cube's top-left row of three subcubes 167 represent the first category of the presentation, i.e., “Background on Martial Arts.” Of these three subcubes, the front-most cube represents the first subcategory (i.e, J=1 and i=1) of “History.” The next cube back (i.e., J=1 and i=2) represents the second subcategory.

Of course, it is not necessary to the invention that the geometrical entity 163 be a cube. The geometrical entity 163 may be any graphical representation of the categories and subcategories in the general format 7. For example, a pyramid, a sphere could also be used. It is even within the scope of the present invention to substitute for the geometrical entity 163 some other item which can be divided into categories and subdivided into subcategories. For example, a map, a keyboard or a group or cans or boxes on a shelf could be used as a representation.

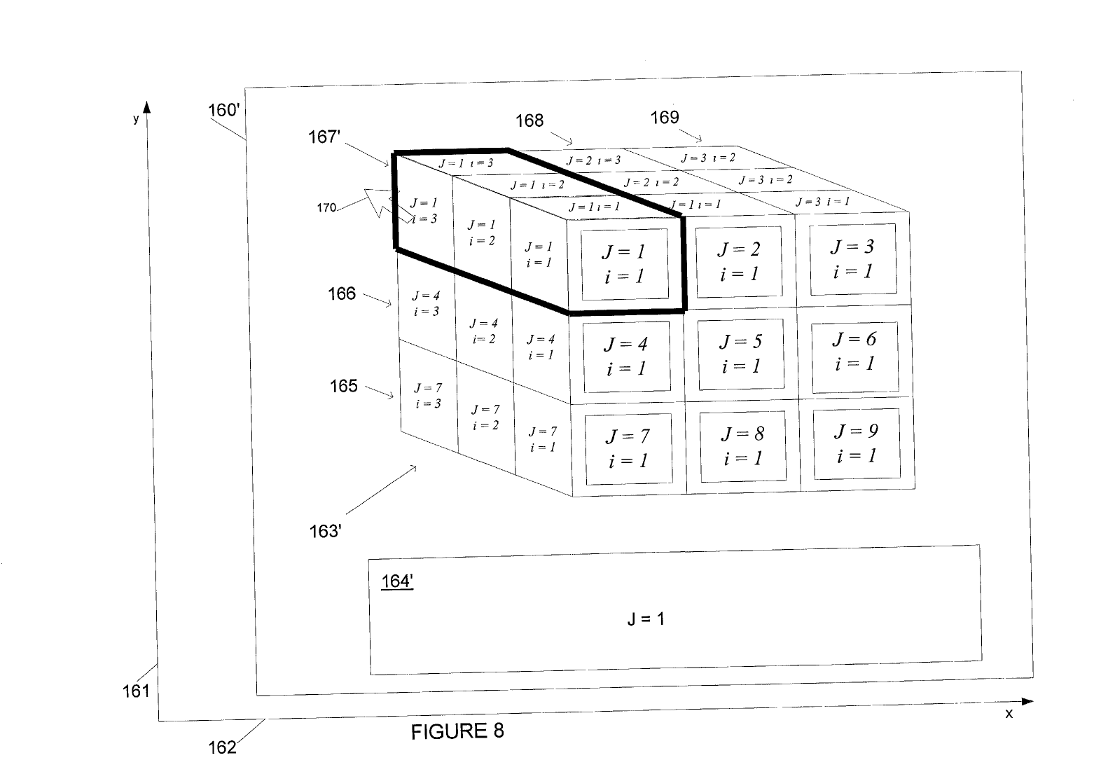

An input device, such as a mouse, may be used to navigate the output form 11 when executed by the viewer. FIG. 8 illustrates a mouse pointer 170 that may be moved around the output form 160′. When the mouse pointer 170 runs over any of the nine main categories (each represented as a subsection of the cube), all of the subcategory components for that category in the geometric representation are highlighted or otherwise displayed. For example, if the mouse pointer 170 runs over any cube where main category J=1, all of the subcategory cubes for J=1 (i.e., J=1, i=1; J=1 i=2; and J=1, i=3) will be highlighted. In an alternative embodiment, the graphical representation 163 may be transparent, so all the subcategories (i=1, 2, and 3 for J=5, 6, 8 and 9) may be seen. The output form may also contain a display box 164′ that will display information related to the currently highlighted category. So, for example, if the first category J=1 is “history” of martial arts, the display box may display an image or text field related to or simply indicating “history” of martial arts.

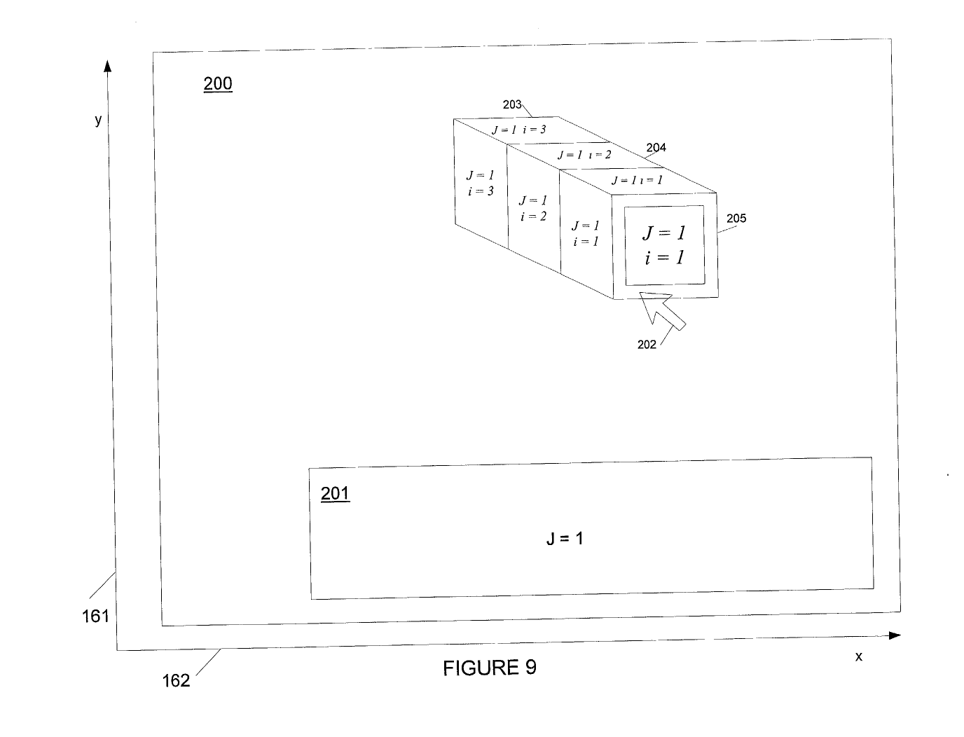

When a user employs an input method, such as the act of clicking a mouse, when the mouse pointer is over a particular category block 167′, the category is activated, and the output form will display the subcategories for the current category, as illustrated in FIG. 9. Each subcategory can then be activated individually by an input method, and the content form 17 for that subcategory will begin to play.

During execution of the presentation, a miniature navigation model of the graphical representation of the content 163 may be displayed at all times, whether on the various content forms shells or in the output form. In this way, a viewer can select a particular set of subcategories 203-205 (as in FIG. 9) and the navigational miniature version of the cube indicates to the viewer which section of the cube is being displayed. This becomes increasingly helpful for cubes of larger sizes.

The construction of the geometrical representation of the instructional 7 format may be done in real time three-dimensional graphics or two-dimensional representations of three-dimensional graphics. Real time three-dimensional rendering allows a user to navigate the geometrical representation 163 in three dimensions. The object 163 may be rotated, translated, or scaled so a user may view it from any angle or perspective. Software methods to develop three-dimensional representations are well appreciated by one ordinarily skilled in the art. Various three dimensional graphics libraries may be used, such as (but not limited to) Direct3D, OpenGL, DirectX, and other 3D libraries and application programming interfaces.

The construction of the geometrical representation of the instructional 7 format may also be done as a two dimensional representation of three-dimensional graphics. Software methods to develop two-dimensional representations of three-dimensional graphics are well appreciated by one ordinarily skilled in the art.

A user may make a selection between different types of output forms, such as the cubic representation illustrated in FIGS. 7, 8 and 9. There may be the option of selecting a pyramid or sphere or any other object. Once an output form is selected, and any necessary information input to activate the display box 164, the user selects which platform it is desired to run the multimedia presentation on. Platform information is stored in a software directory 12, which the content generation application 14 uses when generating the final instructional presentation 13. For example, the platform information may contain all of the necessary software code to generate an executable file in various operating system environments and software platforms such as, but not limited to, the Windows environment, Unix and Unix derivative operating systems, posix compliant operating systems, or MAC operating systems.

The content generation application 14 ultimately uses all of the multimedia content, structured in the output form and the content forms, and the platform software information, and generates the instructional presentation 13. The presentation may be in the form of an executable program. Alternatively, the presentation may be in the form of a web browser readable format, such as in JavaScript.

During execution of the presentation, various sound schemes may be employed which play sound files to enhance the transitions between various states of the instructional presentation and may indicate when a command is given such as to play the video or pause it. For example, if a user clicks on a control command during playback of a video, or clicks on a shortcut box to activate a video, various sound effects, including voice, may be used to enhance the presentation. Furthermore, transition animations may be employed between output form shells and content form shells and between different layers of the output form shells. For example, when a user clicks on the J=1 category in FIG. 8, the bar of information may be animated to slide out of the entire graphical representation. If the graphical representation is a three dimensional interactive model, the animation sequences may be rendered in real time. Animation techniques, both static and dynamic, are well appreciated in the art.

G. A Script-Based Implementation of the User Interface

FIGS. 1 through 6 and the previous discussion have shown how to build a user interface which is presented to the user as a three-dimensional geometric shape (shown in FIGS. 7 through 9) that is subdivided into smaller components so that the geometric shape can be seen as a series of categories each having a series of subcategories. A method has been disclosed which directs the developer of such a user interface through each of the categories and then through each of the subcategories of the categories. During this traversal, the developer associates titles, images, video, and other content to each of the subcategories and categories.

Now, a system will be described which implements the user interface in an object oriented, easily extensible manner using an open system that plays from a series of scripts. The scripts are human readable and writable and instruct the user interface program how to operate for a given presentation.

As previously addressed, the user interface is a geometric shape presented in three dimensions and subdivided. FIGS. 7 and 8 show the user interface as a three-by-three cube composed of 27 sub-elements. For easy of discussion, such a “Learning Cube” (as it is sometimes known) will be described. Of course the invention works well for larger and smaller cubes as well as other shapes (perhaps even non geometric) which can be subdivided. Returning to the 3-by-3 Learning Cube, each “phase” of the Learning Cube is considered to be a “stage”. That is to say that the full cube view, as shown in FIG. 7, is considered a “stage”. The removed row, as shown in FIG. 9, is considered another “stage.” The video player/explorer, shown in FIG. 3 and which may be associated as content for one of the 27 blocks of the Learning Cube is also considered a “stage”.

At startup time, the Learning Cube reads a data script (such as a human readable ASCII file) which includes a list of all of the possible stages. In one embodiment, this data script is saved as STAGES.DAT. The file STAGES.DAT contains the names of all of the stages used by the cube and corresponding data files that tell how those stages will each operate. For example, in one embodiment, the STAGES.DAT script file can be in the form:

// START OF FILE
[stage:

name:cube:
file:cube.dat:
description: the full view of the cube:

]
[stage:

name:row:
file:row.dat:
description: the removed row:

]
[stage:

name:videx:
file:videx.dat:
description: the videx stage:

]
// END OF FILE

In the above example, the STAGES.DAT presentation script contains a description of three stages. The first stage is of name “cube” and is associated with the entire cube as shown in FIG. 7. The “cube” stage has its data and operation instructions in the CUBE.DAT file. The second stage is of name “row” and its data and instructions are contained in the file ROW.DAT. The third stage is of name “videx” and its data and instructions are contained in the VIDEX.DAT file.

In a preferred embodiment, the STAGES.DAT presentation script can be embodied using XML. In such an embodiment, such a script can be:

<stage name=“Main Cube” code_path=“www.l3i.com/quizgame.ocx”/>

<stage name=“IVX Player” code_path=“www.l₃i.com/ivxplayer.ocx”/>

<stage name=“Text Viewer” code_path=“www.l3i.com/text_viewer.ocx”/>

The script from above is a set of stage tags which include object attributes, such as “name” and “code path.” A STAGES.DAT script can also include child data objects. For example, the following format includes details on how each stage handles a mouse event and which graphics to display:

<stage name=“Quiz Game” code_path=“www.l3i.com/quizgame.ocx”>

<picture filename=“smallcube.bmp” x=“5” y=“5” width=“20” height=“40” />
<mouse_event region=“small_cube” command=“RETURN_TO_CUBE” />

</stage>
<stage name=“IVX Player” code_path=“www.l3i.com/ivxplayer.ocx” >

<picture filename=“smallcube.bmp” x=“5” y=“5” width=“20” height=“40” />
<mouse_event region=“small_cube” command=“RETURN_TO_CUBE” />

</stage>
<stage name=“Text Viewer” code_path=“www.l3i.com/text_viewer.ocx” >

<picture filename=“smallcube.bmp” x=“5” y=“5” width=“20” height=“40” />
<mouse_event region=“small_cube” command=“RETURN_TO_CUBE” />

</stage>

In another form, the presentation script can combine all of the details about the cube—the stages, the regions, etc.—into a single file. For example,

<cube name“All About The Martial Arts” >

<region name=“small_cube” points=“0, 0,50,0,50,50,0,50” />
<stage name=“stage1” >

<mouse_event region=“small_cube” command=“RETURN_TO_CUBE” />

</stage>
<stage name=“stage2” >

<mouse_event region=“small_cube” command=“RETURN_TO_CUBE” />

</stage>
<stage name=“stage3” >

<mouse_event region=“small_cube” command=“RETURN_TO_CUBE” />

</stage>

</cube>

In the above script, since there are no code_path attributes on the stages, these stages can be played by the basic cube engine.

One skilled in the art will readily see that by referencing a different data file for each stage, the system can be easily modified, extended, and maintained. New stages or different combination of stages can readily be supported since all that is required is that the stage names be added to the STAGES.DAT along with a reference to a file describing it operations.

As just explained, the STAGES.DAT script informs the main unit of the presentation player what stages are used in the presentation and where the instructions and data for those stages resides. For example, for the “cube” stage, this information is found in the CUBE.DAT file (again in ASCII). Such an instruction script could be:

// START OF FILE
[pict:bg01.bmp]
[pict:cube.bmp]
[click_event:

region:row1:
command:goto_stage:
command parm:stage_row]

// END OF FILE

The data file above first lists the pictures that the user interface program will display for the cube stage. These pictures are loaded by the engine program (also known as the presentation control unit) and displayed automatically when the cube stage starts. The data file then contains a click event. The click event names a region of the screen “row1” and a command that the cube will perform when a mouse click is performed on that region. Such a data file can also configure the system to play special sounds when the mouse moves over an area on the screen. In general, it instructs the system how to manage the graphical user interface. Using this methodology, the cube gains more and more flexibility as the behavior of the Learning Cube is can be modified or enhanced by adding new or different functionality references in the various stage data script files.

In addition to the stages and the stage data, there are other data script files used by the Learning Cube's user interface program that contain basic cube resource data. For example, in one embodiment, there are three additional data scripts used by the presentation program: PICTURES.DAT, REGIONS.DAT and SOUNDS.DAT. In one embodiment, the PICTURES.DAT data file contains a list of pictures used by the cube, their file names and parameters. Parameters for the pictures which are found in this file include transparency flags, dimensions, and so on. The data file REGIONS.DAT contains a list of regions used by the cube. The regions are areas of the screen or hotspots that are named. For example, a developer can list a region of the screen in the upper right corner of the display and call it “UR_Place”. Based on this definition, other data files can reference the UR_Place region. The data file SOUNDS.DAT contains a list of sounds used by the cube. The sounds are segments of audio files that are named. The segments are determined by a “from” time and a “to” time. For example, if there is an audio file that contains the word “Hello,” the developer can create a sound listing in this data file called “snd_hello” which states is associated with perhaps the millisecond offset of 20000 and ends at 22000. Once defined, a sound can be referenced elsewhere by its name, such as “snd_hello.”

As previously discussed, the main user interface program parses the various data scripts and runs accordingly. Due to the open, object oriented framework of the present invention, this ‘cube engine’ only needs to be compiled one time and can then be distributed to users on the web or other network. The cube engine does not contain any stages. Rather, it can dynamically import and run stages. Thus, to add a stage to a cube, the code to present the stage can be created in isolation and it can dynamically attach to the existing cube code without the previous cube code being recompiled.

In practical terms, when the cube engine is invoked, it is given the name of a data file containing a list of the modular stages which it will be using. In the previous example, this data file was named STAGES.DAT. The data file contains a list of the stage names, descriptions of the stages (such as what images are used in the stages and what content type or template to use), and paths to the compiled stage module code (if that compiled code is not already supported by the cube engine). The cube then dynamically loads this compiled stage code and instructs the stage code to register itself. Such registration is accomplished by the stage code passing an interface to the cube, which is a block of data which contains pointers to functions within a stage module. Once the stages are loaded in this manner, the learning cube may easily invoke any of the functions contained in the interface.

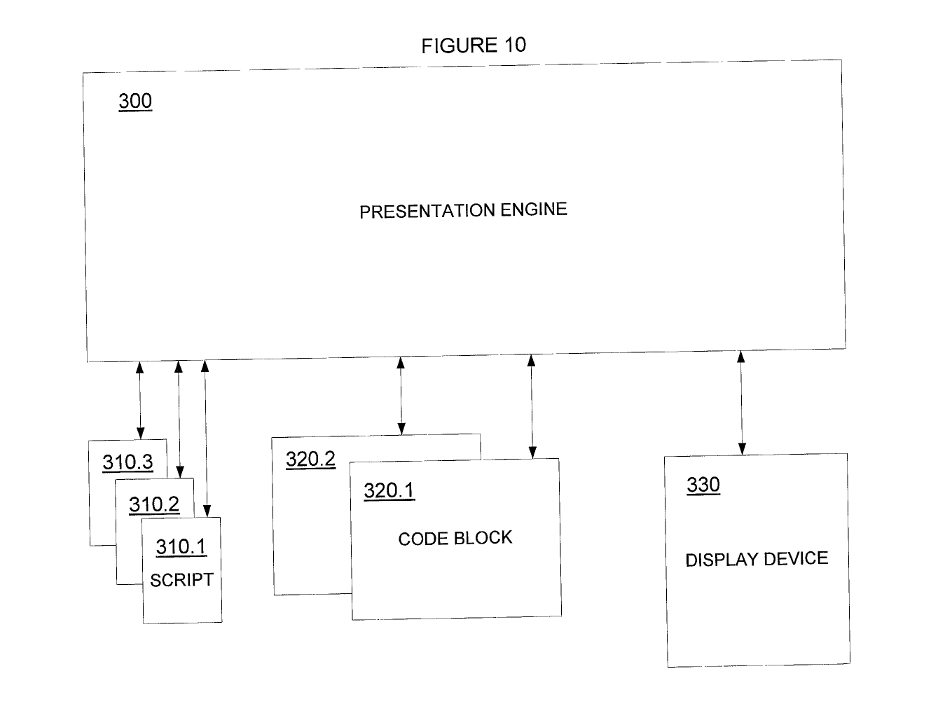

FIG. 10 is a block diagram illustrating how the presentation engine relies on script data files to provide the graphical user interface to the end user. In FIG. 10, the presentation engine 300 resides as a computer application on the end user's computer, on a server of a network, as an web applet, or the like. The presentation engine 300 parses scripts 310, such as the previously described STAGES.DAT, PICTURES.DAT, REGIONS.DAT and SOUNDS.DAT. Stages which are already supported by the presentation engine 300 will reference routines within the presentation engine itself. The scripts will reference external code for new or enhanced stage functionality. The presentation engine 300 can dynamically link these new code blocks 320. During operation, the user browses through the graphical user interface 330 which is presented on a video display and controlled by the presentation engine 300.

While the specification describes particular embodiments of the present invention, those of ordinary skill can devise variations of the present invention without departing from the inventive concept.

We claim:

1. A multidimensional multimedia player for delivering to a user a multimedia presentation comprised of a plurality of multimedia content, the multimedia player comprising:
a presentation control unit which provides a graphical user interface on a display device for allowing the user to manipulate the multimedia presentation; and
a presentation script for the comprising at least one stage for representing a view of the graphical user interface, wherein the stage comprises a stage description and a reference to a stage presentation module;
wherein the graphical user interface is a three-dimensional geometric shape comprised of a set of category-identifying elements;
wherein each category-identifying element is associated with a set of subcategory-identifying elements;
wherein each of the category-identifying elements and each of the subcategory-identifying elements has been associated with one of the stages in the presentation script; and
wherein when the user selects one of the subcategory-identifying elements, the presentation control unit displays to the user the multimedia content which has been associated to the subcategory-identifying element according to the presentation script.

2. The multidimensional multimedia player from claim 1, wherein the reference to the stage presentation module is a path to a compiled stage module code.

3. The multidimensional multimedia player from claim 1, wherein the reference to the stage presentation module is a reference to a portion of the presentation control unit which can present the stage.

4. The multidimensional multimedia player from claim 1, wherein the three-dimensional geometric shape is a cube.

5. The multidimensional multimedia player from claim 1, wherein the presentation control unit and the presentation script are delivered to a computer over the Internet.

6. The multidimensional multimedia player from claim 1, further comprising an instruction script, for instructing the presentation control unit how to manage the graphical user interface.

7. A multidimensional multimedia player for delivering to a user a multimedia presentation comprised of a plurality of multimedia content and a presentation script, wherein the presentation script comprises at least one stage for representing a view of a graphical user interface, wherein the stage comprises a stage description and a reference to a stage presentation module, wherein the graphical user interface is a three-dimensional geometric shape comprised of a set of category-identifying elements; wherein each category-identifying element is associated with a set of subcategory-identifying elements; wherein each of the category-identifying elements and each of the subcategory-identifying elements has been associated with one of the stages in the presentation script; the multimedia player comprising:
a presentation control unit which provides the graphical user interface on a display device for allowing the user to manipulate the multimedia presentation; and
wherein when the user selects one of the subcategory-identifying elements, the presentation control unit displays to the user the multimedia content which has been associated to the subcategory-identifying element according to the presentation script.

8. The multidimensional multimedia player from claim 7, wherein the reference to the stage presentation module is a path to a compiled stage module code which integrate with the presentation control unit.

9. The multidimensional multimedia player from claim 7, wherein the reference to the stage presentation module is a reference to a portion of the presentation control unit which can present the stage.

10. The multidimensional multimedia player from claim 7, wherein the three-dimensional geometric shape is a cube.

11. The multidimensional multimedia player from claim 7, wherein the presentation control unit and the presentation script are delivered to a computer over the Internet.

12. The multidimensional multimedia player from claim 7, wherein the presentation control unit manages the graphical user interface according to an instruction script.

13. A computerized method for delivering to a user a multimedia presentation comprised of a plurality of multimedia content, the method comprising:
controlling a graphical user interface on a display device for allowing the user to manipulate the multimedia presentation, wherein the graphical user interface is a three-dimensional geometric shape comprised of a set of category-identifying elements;
parsing a presentation script, the presentation script comprising at least one stage for representing a view of the graphical user interface, wherein the stage comprises a stage description and a reference to a stage presentation module;
associating each category-identifying element with a set of subcategory-identifying elements;
associating each of the category-identifying elements and each of the subcategory-identifying elements with one of the stages in the presentation script; and
displaying to the user the multimedia content which has been associated to the subcategory-identifying element when the user selects one of the subcategory-identifying elements, according to the presentation script.

14. The computerized method from claim 13, wherein the reference to the stage presentation module is a path to a compiled stage module code.

15. The computerized method from claim 13, wherein the reference to the stage presentation module is a reference to a portion of the presentation control unit which can present the stage.

16. The computerized method from claim 13, wherein the three-dimensional geometric shape is a cube.

17. The computerized method from claim 13, wherein the presentation script is delivered to a computer over the Internet.

18. The computerized method from claim 13, further comprising parsing an instruction script, for instructing how to manage the graphical user interface.

19. A computer-readable medium having computer-executable instructions for performing a method for delivering to a user a multimedia presentation comprised of a plurality of multimedia content, the method comprising:
controlling a graphical user interface on a display device for allowing the user to manipulate the multimedia presentation, wherein the graphical user interface is a three-dimensional geometric shape comprised of a set of category-identifying elements;
parsing a presentation script, the presentation script comprising at least one stage for representing a view of the graphical user interface, wherein the stage comprises a stage description and a reference to a stage presentation module;
associating each category-identifying element with a set of subcategory-identifying elements;
associating each of the category-identifying elements and each of the subcategory-identifying elements with one of the stages in the presentation script; and
displaying to the user the multimedia content which has been associated to the subcategory-identifying element when the user selects one of the subcategory-identifying elements, according to the presentation script.

20. The computer-readable medium having computer-executable instructions for performing a method from claim 19, wherein the reference to the stage presentation module is a path to a compiled stage module code.

21. The computer-readable medium having computer-executable instructions for performing a method from claim 19, wherein the reference to the stage presentation module is a reference to a portion of the presentation control unit which can present the stage.

22. The computer-readable medium having computer-executable instructions for performing a method from claim 19, wherein the three-dimensional geometric shape is a cube.

23. The computer-readable medium having computer-executable instructions for performing a method from claim 19, wherein the presentation script is delivered to a computer over the Internet.

24. The computer-readable medium having computer-executable instructions for performing a method from claim 19, the method further comprising parsing an instruction script, for instructing how to manage the graphical user interface.

25. A computerized authoring tool for creating a multidimensional multimedia presentation having a set of categories, each category having a set of subcategories, the authoring tool comprising:
a number selection unit, for specifying a number of category elements and subcategory elements within a graphical user interface, wherein the graphical user interface has a three-dimensional geometric shape comprised of the desired number of category-identifying elements and the desired number of subcategory-identifying elements; and
a content association unit which is programmed to:
loop through each of the category-identifying elements as a current element to:
associate a category title to the current element; and
loop through each of the subcategory-identifying elements for the current category as a current sub-element to:
associate a subcategory title to the current sub-element; and
associate content to the current sub-element.

26. The computerized authoring tool from claim 25, wherein the content association unit creates a script describing the associations of the category title to the category-identifying elements.

27. The computerized authoring tool from claim 25, wherein the content association unit creates a script describing the associations of the subcategory titles and content to the subcategory-identifying elements.

28. The computerized authoring tool from claim 25, wherein the content association unit creates a script describing how to manage the graphical user interface.

29. The computerized authoring tool from claim 25, wherein the geometric shape of the graphical user interface is a cube.

30. A computerized method for creating a multidimensional multimedia presentation having a set of categories, each category having a set of subcategories, the method comprising:
determining a number of categories and a number of subcategories for the multimedia presentation;
specifying a graphical user interface having a three-dimensional geometric shape, wherein the geometric shape is comprised of the desired number of category-identifying elements and the desired number of subcategory-identifying elements;
looping through each of the category-identifying elements as a current element by:
associating a category title to the current element; and
looping through each of the subcategory-identifying elements for the current category as a current sub-element by:
associating a subcategory title to the current sub-element; and
associating content to the current sub-element.

31. The computerized method for creating a multidimensional multimedia presentation from claim 30, further comprising creating a script describing the associations of the category title to the category-identifying elements.

32. The computerized method for creating a multidimensional multimedia presentation from claim 30, further comprising creating a script describing the associations of the subcategory titles and content to the subcategory-identifying elements.

33. The computerized method for creating a multidimensional multimedia presentation from claim 30, further comprising creating a script describing how to manage the graphical user interface.

34. The computerized method for creating a multidimensional multimedia presentation from claim 30, wherein the geometric shape of the graphical user interface is a cube.

35. A computer-readable medium having computer-executable instructions for performing a method of creating a multidimensional multimedia presentation having a set of categories, each category having a set of subcategories, the method comprising:
determining a number of categories and a number of subcategories for the multimedia presentation;
specifying a graphical user interface having a three-dimensional geometric shape, wherein the geometric shape is comprised of the desired number of category-identifying elements and the desired number of subcategory-identifying elements;
looping through each of the category-identifying elements as a current element by:
associating a category title to the current element; and
looping through each of the subcategory-identifying elements for the current category as a current sub-element by:
associating a subcategory title to the current sub-element; and
associating content to the current sub-element.

36. The computer-readable medium having computer-executable instructions for performing a method of creating a multidimensional multimedia presentation from claim 35, the method further comprising creating a script describing the associations of the category title to the category-identifying elements.

37. The computer-readable medium having computer-executable instructions for performing a method of creating a multidimensional multimedia presentation from claim 35, the method further comprising creating a script describing the associations of the subcategory titles and content to the subcategory-identifying elements.

38. The computer-readable medium having computer-executable instructions for performing a method of creating a multidimensional multimedia presentation from claim 35, the method further comprising creating a script describing how to manage the graphical user interface.

39. The computer-readable medium having computer-executable instructions for performing a method of creating a multidimensional multimedia presentation from claim 35, wherein the geometric shape of the graphical user interface is a cube.
